(19) United States
(12) Patent Application Publication
(10) Pub. No.: US 2020/0365302 A1
(43) Pub. Date: Nov. 19, 2020

(54) High Pressure Gas Atomization Process for Preparing Soft Nanocomposite Magnetic Materials

(71) Applicant: Aegis Technology Inc., Santa Ana, CA (US)

(72) Inventors: Qi Chen, Santa Ana, CA (US); Zhigang Lin, Santa Ana, CA (US)

(21) Appl. No.: 16/414,688

(22) Filed: May 16, 2019

(51) Int. Cl. H01F 1/153; B22F 9/08

(52) U.S. Cl. CPC H01F 1/1535; H01F 1/15333; B22F 2998/10; B22F 9/082; H01F 1/15316

(57) ABSTRACT

High-pressure gas atomization (HPGA) process produces high-quality metal powder and alloy materials including soft magnetic materials. HPGA includes: (a) melting a metal to form a liquid metal; (b) forming a continuous stream of the metal liquid; and (c) directing high-pressure inert gas into the continuous stream of liquid metal to generate droplets of the liquid metal, whereby the droplets solidify to form particles that exhibit soft magnetic properties. The high-pressure inert gas quenches or cools the liquid metal at speeds of up to 5×10⁵° C. per second. The soft magnetic alloy powder is spherical-shaped with particle sizes of between 1 μm and 5 μm and comprises a mixture of amorphous and microcrystalline phases with a narrow size distribution. These features facilitate consolidation into various products including near-net shape magnets. Annealing yields nanocrystal phases including a-CoFe or a-Fe phase that is embedded in amorphous matrix.

This invention was made with Government support under SBIR Grant No. DE-SC0012055 awarded by the U.S. Department of Energy to Aegis Technology Inc. The Government has certain rights to the invention.

### FIELD OF THE INVENTION

The present invention generally relates to a high-pressure gas atomization (HPGA) process for producing high-quality metal powder and alloy materials including soft magnetic materials.

### BACKGROUND OF THE INVENTION

Melt-spinning has been used to make amorphous ribbons including alloys such as FeSiNbCuB and FeZrNbCu which are commercially available under the names FINEMET and NANOPERM, respectively and CoFeSiNbCuB and FeCoZrBCu which are prototypes as HITPERM. When manufacturing soft magnetic materials, an ingot containing the targeted alloy having the targeted composition is prepared by arc melting in an argon atmosphere. Amorphous ribbons are produced from the ingot using a single wheel melt-spinning technique. The process begins with re-melting of the arc-melted ingot in a boron nitride crucible in an argon atmosphere. A small amount of argon gas is used to quench the molten targeted alloy onto a Cu—Be wheel, which can reach quench speeds of one million ° C./second, in order to obtain an amorphous structure. The melt-spun ribbons are annealed isothermally during a crystallization process to form a two-phase structure that includes nanocrystal that is embedded in an amorphous matrix. The nanocrystals are α-CoFe for HITPERM and a-Fe for FINEMET and NANOPERM.

Because of the eutectic requirements in forming amorphous precursors, melt-spinning is not suitable for some alloy compositions. In some applications, Zr and B are added to improve glass formation and Nb and Cu are needed to reduce the grain size during melt-spinning. Melt-spinning, which an expensive process that requires costly equipment, is not suitable for fabricating FINEMET, NANOPERM and HITPERM alloys at commercial scales. In addition, with the melt-spun process it is usually difficult to define and control both the nature and extent of the grain boundary phase associated with crystal chemistry which is needed to tailor phase constituents and microstructure in order to meet targeted structure and magnetic properties. Furthermore, surface crystallization, which is commonly observed in melt-spun ribbons, is not desirable for soft magnetic materials because it causes texture layers that diminish magnetic performance.

### SUMMARY OF THE INVENTION

The present invention is based, in part, on the development of a low-cost and scalable high-pressure gas atomization (HPGA) process for producing high-quality metal powder and alloy materials including soft magnetic materials.

In one aspect, the invention is directed to a method of producing soft magnetic materials that includes:

(a) melting a metal to form a liquid metal;

(b) forming a continuous stream of the metal liquid; and

(c) directing high-pressure inert gas into the continuous stream of liquid metal to generate droplets of the liquid metal, whereby the droplets solidify to form particles that exhibit soft magnetic properties. The high-pressure inert gas, which is preferably applied at a pressure of 800 to 1000 psi, quenches or cools the liquid metal at speeds of up to 5×10⁵° C. per second. The soft magnetic alloy powder is spherical-shaped with particle sizes of between 1 μm and 5 μm and comprises a mixture of amorphous and microcrystalline phases with a narrow size distribution. These features facilitate consolidation into various products including near-net shape magnets.

The microstructure of the atomized powders from HPGA can be tailored by using low temperature annealing to produce a high induction nanocrystal phase in an amorphous matrix. For example, an α-CoFe nanocrystal phase can be produced in HITPERM and a high induction a-Fe nanocrystal phase can be produced in FINEMET, where the nanocrystal phase has sizes smaller than 100 nm within an amorphous matrix. Magnetic powders containing α-CoFe or a-Fe with sizes smaller than 40 nm oftentimes result in an increase of the Curie temperature of the magnetic materials, thereby increasing operating temperature, and providing low magnetostrictive coefficient without negatively affecting their mechanical properties. Theoretical calculations for metallic ferromagnetic nanoparticle composites suggest that small inter-particles can offer higher resistivity and therefore reduce power loss due to eddy currents.

HPGA is particularly suited for fabricating soft magnetic nanocomposite materials including soft magnet alloys containing α-CoFe (e.g. HITPERM) and soft magnet alloys containing a-Fe (e.g. FINEMET), as well Fe-M-B—Cu (M=Zr or Nb) soft magnet alloys (e.g. NANOPERM). HPGA can produce higher-quality metal and alloys powders at a lower cost than conventional melt-spun. In addition, crystallization of melt-spun amorphous alloys often leads to minority phases and devitrification of the amorphous grain boundary phase because of the high annealing temperatures used in their crystallization process. Furthermore, the grain boundary phases need to be well controlled in order to achieve desired phase constituents and microstructure for targeted magnetic properties, but it is usually difficult to define both the nature and extent of the grain boundary phase associated with crystal chemistry and to tailor phase constituents and microstructure to achieve the targeted structural and magnetic properties.

HPGA is more flexible than melt-spinning in that a greater variety of compositions can be used in forming the amorphous phase, in alloying and in controlling the impurity levels. In addition, high powder production rates of HPGA process make this technology viable and competent, both economically and technically, and make it flexible to control powder size, composition, size distribution, shape and surface morphology during HPGA process. Furthermore, HPGA can produce highly alloyed specialty-alloy-powders because the atomized powders are preferably pre-alloyed and exhibit high composition homogeneity. Finally, surface crystallization, which is commonly observed in melt-spun ribbons, is not desirable for soft magnetic performance because it causes texture layers and has a negative effect on magnetic properties; surface crystallization can be minimized with HPGA.

HPGA systems are less expensive to construct and operate than melt-spinning devices; moreover, HPGA can be readily scaled-up to produce large quantities of alloy powder ranging from 15 kg to 25 kg per batch or more. HPGA yields fine, clean, spherical-shaped, microscale sized powders can be compacted into high density products.

### BRIEF DESCRIPTION OF THE DRAWINGS

FIG. 1A is a HPGA system and FIG. 1B is the nozzles arrangement.

FIGS. 2A, 2B, 2C and 2D depicts the crystallization process of amorphous (Co_{0.35}Fe_{0.65})₈₈Zr₇B₄Cu₁ and (Co_{0.35}Fe_{0.65})_{73.5}Si_{15.5}Nb₃B₇Cu₁ during annealing of (HITPERM) alloy powders.

FIGS. 3A, 3B, 3C, 3D and 3E are SEM images showing microstructures: Fe_{73.5}Si_{15.5}Nb₃B₇Cu₁, (Co_{0.35}Fe_{0.65})_{73.5}Si_{15.5}Nb₃B₇Cu₁, (Co_{0.35}Fe_{0.65})_{73.5}Si_{13.5}Nb₃B₉Cu₁, (Cu_{0.35}Fe_{0.65})₈₈Zr₇B₄Cu₁, and (Cu_{0.35}Fe_{0.65})₈₈Zr₇B₄Cu₁, respectively.

FIGS. 4A and 4B are XRD patterns of HITPERM-type (Co_{0.35}Fe_{0.65})_{73.5}Si_{15.5}Nb₃B₇Cu₁ and FINEMT-type Fe_{73.5}Si_{15.5}Nb₃B₇Cu₁ alloy powders, respectively.

FIGS. 5A, 5B, 5C and 5D are HRTEM images of (Co_{0.35}Fe_{0.65})_{73.5}Si_{15.5}Nb₃B₇Cu₁ and FINEMET-type Fe_{73.5}Si_{13.5}Nb₃B₉Cu₁ alloy powders prepared by HPGA.

FIGS. 6A and 6B are HRTEM images of (Co_{0.35}Fe_{0.65})_{73.5}Zr₇B₄Cu₁ alloy powders prepared by HPGA.

FIG. 7 is a hysteresis loop for about 5 μm (Co_{0.35}Fe_{0.65})_{73.5}Si_{15.5}Nb₃B₇Cu₁ prepared by the HPGA.

FIG. 8 is a hysteresis loop for annealed (Co_{0.35}Fe_{0.65})_{73.5}Si_{15.5}Nb₃B₇Cu₁.

FIG. 9 is a hysteresis loop for about 5 μm FINEMET-type Fe_{73.5}Si_{13.5}Nb₃B₉Cu₁.

FIG. 10 is a hysteresis loop for annealed FINEMET-type Fe_{73.5}Si_{13.5}Nb₃B₉Cu₁

### DETAILED DESCRIPTION OF PREFERRED EMBODIMENTS

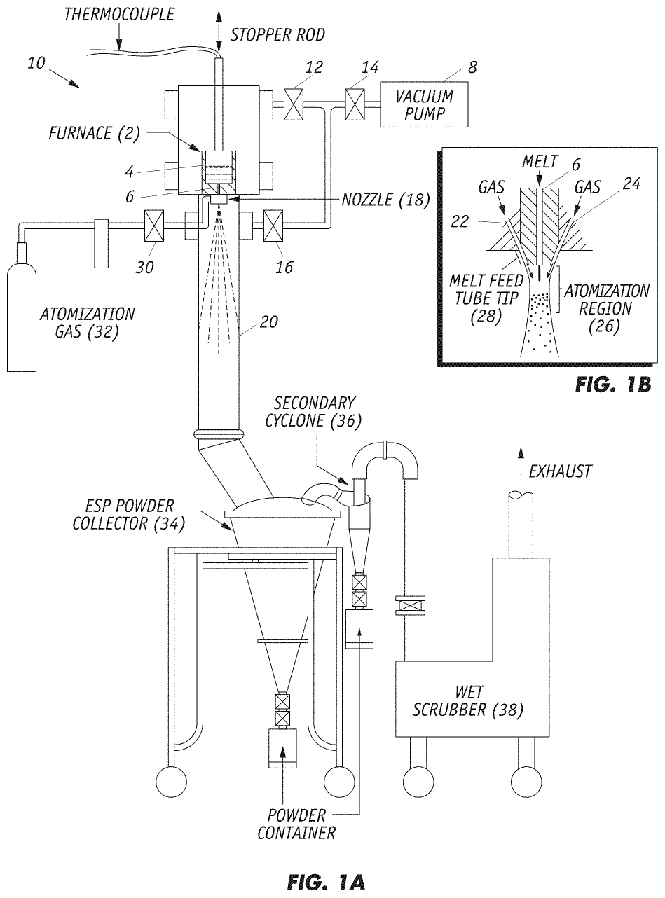

FIGS. 1A and 1B illustrate a high-pressure gas atomization (HPGA) system for preparing soft magnetic materials. Selected metals such as alloy ingots are melted in a ceramic (e.g., alumina) crucible 4 of a furnace 2 to yield a liquid metal. Typically, the metal is superheated to a temperature of 1500-1550° C. (or higher) and held at this temperature for about 3 minutes to insure complete homogenization of the melt temperature and composition. The metal is preferably heated in vacuum or an inert gas environment. Vacuum pump 8 is connected to furnace 2 via valves 12, 14 and to an atomization spray chamber 20 via valves 16, 14. The liquid metal flow through an elongated channel 6 that is connected to nozzle arrangement 18. The length of channel 6 is preferably sufficiently long that the liquid metal flows through the exit of the channel 6 as a continuous stream of liquid metal into the atomization chamber 20.

As shown in FIG. 1B, the nozzle arrangement has an exit for the channel 6 at the melt feed tube tip 28. Gas is supplied through conduits 22, 24, each of which has an outlet or nozzle that directs a jet of high-pressure gas into the stream of liquid metal. An atomization gas source 32 supplies inert as such as ultra-high pure Ar or N₂, at a pressure of 800-1000 psi, through valve 30 to the gas conduits. Instead of employing a plurality of discrete gas nozzles that direct jets of high-pressure gas into the liquid metal, an annular ring can be employed to direct a ring-shaped stream of gas into the liquid metal. As the high-pressure gas streams impinge on the liquid metal stream, the liquid metal atomizes and breaks into liquid metal droplets. As the droplets continue to descend down the atomization chamber 20, the droplets solidify into spherical metal powder particles. The spray chamber 20 is preferably backfilled with Ar or Nz.

In a preferred embodiment as depicted in FIG. 1B, the liquid metal exits the aperture of channel 6 and flows a certain distance under gravity or pressure before being impacted by the high-pressure gas within the atomization region 26 that is within the upper portion atomization chamber 20. Channel 6 preferably has an elongated bore with a length of 10.4 mm and inner diameter of 1.32 mm (0.408 inch). Channels with longer lengths and wider diameters are used in preparing larger quantities of soft magnetic materials. The elongated bore assures that the liquid metal exits into the atomization chamber 20 as a continuous stream. The droplets cool and solidify rapidly as they fall downward inside atomization chamber 20. As a result of the impingement of the high-pressure gas onto the melt stream, the cooling rate of the droplets range from 1×10⁵ to 5×10⁵° C./s.

Powder removed from a primary cyclone collector 34, such as an electrostatic precipitator powder collector (ESP), and secondary cyclone 36 can be further sieved in ambient environment using standard methods into different size particles, including powders with diameters that range between 1 μm to 5 μm. A wet scrubber 38 removes remaining materials from the exhaust gas.

The powders can comprise a mixture of amorphous and microcrystal phases that can be further processed. In the case of FINEMET, NANOPERM, and HITPERM powders, it has been demonstrated that a low temperature annealing will cause nanocrystal phases such as α-CoFe and a-Fe to become embedded in an amorphous matrix that is formed during the crystallization process. Typically, the annealing temperature is from 300 to 600° C. and preferably from 500 to 600° C. Annealing at a low annealing temperature causes crystallization within the particles to form nanocrystal phases of α-CoFe or a-Fe with diameters that range from 5 to 10 nm. With respect to the preparation of nanocomposites, HPGA can generate a mixture of amorphous and microcrystalline powders, so that the microstructure of the atomized powders can be easily tailored by lowering the annealing temperature than the temperature used for melt-spinning of ribbons to produce high induction α-CoFe phase on HITPERM and a-Fe phase in FINEMET and NANOPERM with sizes smaller than 10 nm. This results in an increase of the Curie temperature for the soft magnetic materials, thereby increasing operating temperatures, high induction, low magnetostrictive coefficients, and low hysteretic and eddy current losses, without compromising the mechanical properties.

The HPGA process was used to make soft magnetic nanocomposite materials including: (i) soft magnet alloys containing α-CoFe (e.g. HITPERM), (2) soft magnet alloys containing a-Fe (e.g. FINEMET), and (3) Fe-M-B—Cu (M=Zr or Nb) soft magnet alloys (e.g. NANOPERM). In particular, (Co_{0.35}Fe_{0.65})_{73.5}Si_{15.5}Nb₃B₇Cu₁, Fe_{73.5}Si_{13.5}Nb₃B₉Cu₁ and (Co_{0.35}Fe_{0.65})₈₈Zr₇B₄Cu₁ powders that have α-CoFe and a-Fe nanocrystal phases embedded in an amorphous matrix were prepared. FINEMET, NANOPERM or HITPERM compositions that contain an a-Co₃₅Fe₆₅ phase facilitates the formation of an amorphous alloy with HPGA by satisfying the eutectic requirements for the formation of amorphous precursors. In addition, the presence of the a-Co₃₅Fe₆₅ phase enhances their magnetic properties such as maximum saturation magnetization. The resultant nanocomposite powders would contain α-CoFe and a-Fe nanocrystal phase embedded in amorphous matrix for both (Co_{0.35}Fe_{0.65})_{73.5}Si_{15.5}Nb₃B₇Cu₁ and Fe_{73.5}Si_{13.5}Nb₃B₉Cu₁ powders respectively. A subsequent low temperature annealing facilitates the formation of the α-CoFe in both (Co_{0.35}Fe_{0.65})_{73.5}Si_{15.5}Nb₃B₇Cu and (Co_{0.35}Fe_{0.65})₈₈Zr₇B₄Cu₁ powders and of the a-Fe nanocrystal in Fe_{73.5}Si_{13.5}Nb₃B₉Cu₁ from amorphous phase, which can therefore lead to a decrease in H_{c} and power loss of nanocomposites for use in power electronics and hybrid electric vehicles.

In preparing (Co_{0.35}Fe_{0.65})_{73.5}Si_{15.5}Nb₃B₇Cu₁, alloy ingots containing Co, Fe, Si, Nb, B and Cu were prepared by plasma arch melting a mixture of these constituent elemental metals. The relative molar amounts of each metal in the mixture were in proportional to that of the soft magnet alloy. The ingots with the pre-alloyed compositions were induction-heated in an alumina crucible to a superheat of 1500-1550° C. The powders recovered from the HPGA process were annealed at a temperature of 2 for 5 hours to crystallize the α-CoFe and a-Fe phases from the amorphous matrix. The FINEMET powders from the HPGA process had a saturation magnetization (Mₛ) of 85 emu/g and Hc of 1.4 Oe. In comparison, FINEMET made by melt-spun process typically has a Mₛ of 100 emu/g and Hc of 0.01−1 Oe.

In preparing Fe_{73.5}Si_{13.5}Nb₃B₉Cu₁, alloy ingots containing Fe, Si, Nb, B and Cu were prepared by plasma arch melting a mixture of these constituent elemental metals. The relative molar amounts of each metal in the mixture were in proportional to that of the soft magnet alloy. The ingots with the pre-alloyed compositions were induction-heated in an alumina crucible to a superheat of 1500-1550° C. The powders recovered from the HPGA process were annealed at a temperature of 600° C. for 2-5 hours to crystallize the α-CoFe and a-Fe phases from the amorphous matrix. The Co-added FINEMET powders recovered from the HPGA had a Mₛ of 95 emu/g and Hc of 4 Oe. In comparison, Co-added FINEMET made by melt-spun process typically has a Mₛ of 150 emu/g and Hc of 1-2.5 Oe range.

In preparing (Co_{0.35}Fe_{0.65})₈₈Zr₇B₄Cu₁, alloy ingots containing Co, Fe, Zr, B and Cu were prepared by plasma arch melting a mixture of these constituent elemental metals. The relative molar amounts of each metal in the mixture were in proportional to that of the soft magnet alloy. The ingots with the pre-alloyed compositions were induction-heated in an alumina crucible to a superheat of 1500-1550° C. The powders recovered from the HPGA process were annealed at a temperature of 600° C. for 2-5 hours to crystallize the α-CoFe and a-Fe phases from the amorphous matrix.

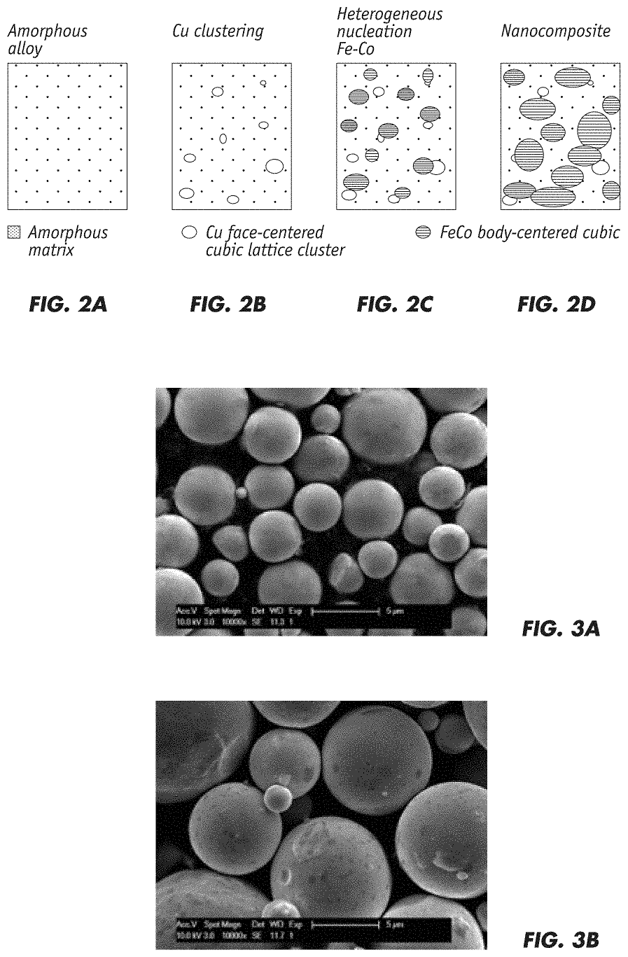

FIGS. 2A, 2B, 2C and 2D illustrate the crystallization or nucleation process of amorphous (Co_{0.35}Fe_{0.65})₈₈Zr₇B₄Cu₁ and (Co_{0.35}Fe_{0.65})_{73.5}Si_{15.5}Nb₃B₇Cu₁ powders that occurs in the annealing stage. FIG. 2A depicts the amorphous matrix of the alloy powders derived from the HPGA process. As annealing proceeds, Cu clustering forms within the matrix as shown in FIG. 2B. Next, heterogeneous nucleation of the α-CoFe nanocrystalline phase appears as shown in FIG. 2C. Finally, a nanocomposite alloy containing the α-CoFe phase within the amorphous matrix develops as shown in FIG. 2D. Similarly, in the annealing of FILAMENT alloy powders, crystallization or nucleation of the a-Fe phase within the amorphous phase also occurs. The microstructure of atomized powders can be modified and tailored by annealing at lower temperatures. In particular, lower annealing temperatures can prevent formation of minority phases and devitrification of the amorphous grain boundary phase caused by high annealing temperatures, which often takes place in melt-spun process.

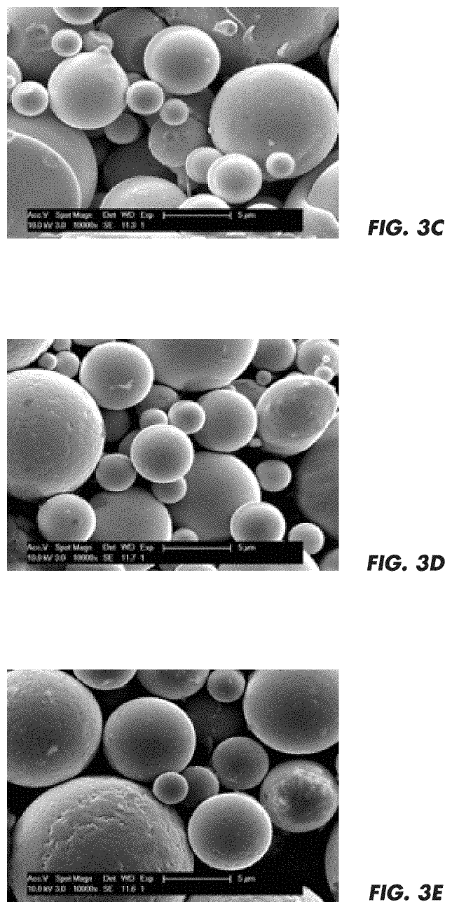

FIGS. 3A-3E are scanning electron microscope images of Fe_{73.5}Si_{15.5}Nb₃B₇Cu₁, (Co_{0.35}Fe_{0.65})_{73.5}Si_{15.5}Nb₃B₇Cu₁, (Cu_{0.35}Fe_{0.65})_{73.5}Si_{13.5}Nb₃B₉Cu₁, (Co_{0.35}Fe_{0.65})₈₈Zr₇B₄Cu₁, and (Co_{0.35}Fe_{0.65})₈₈Zr₇B₄Cu₁ powders. The particles exhibit uniform spherical shapes and have sizes from about 1 μm to 5 μm.

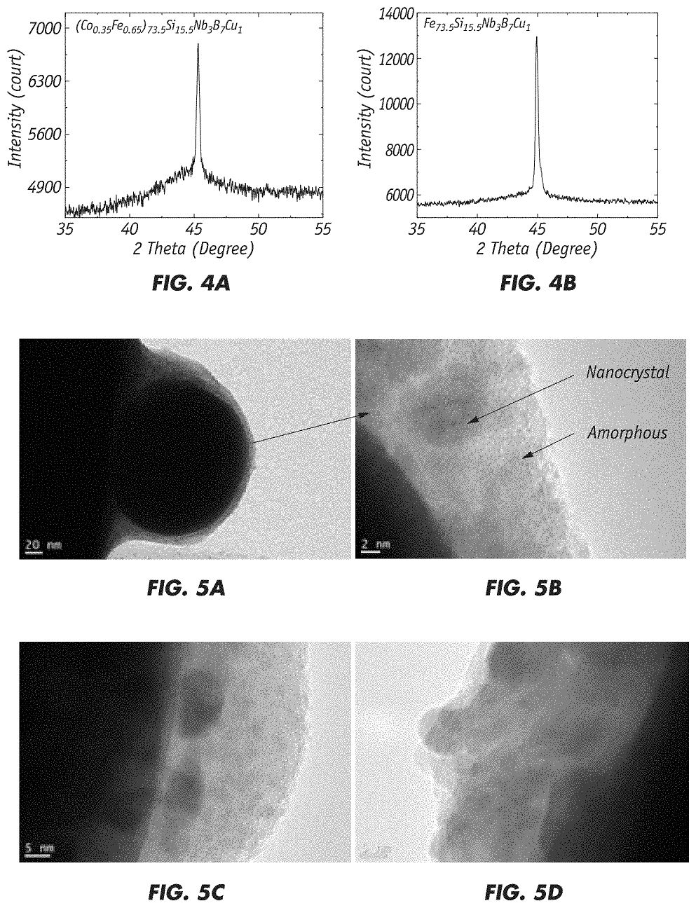

FIGS. 4A and 4B are X-ray diffraction patterns of (Co_{0.35}Fe_{0.65})_{73.5}Si_{15.5}Nb₃B₇Cu₁ and Fe_{73.5}Si_{13.5}Nb₃B₉Cu₁ powders, respectively, that were prepared by HPGA. In FIG. 4A the XRD peak indicates the presence to the α-CoFe phase within an amorphous phase. In FIG. 4B the XRD peak indicates the presence to the a-Fe phase within an amorphous phase.

FIGS. 5A and 5B are high-resolution transmission electron microscopy images of (Co_{0.35}Fe_{0.65})_{73.5}Si_{15.5}Nb₃B₇Cu₁ alloy powders prepared by HPGA. FIG. 5A shows α-CoFe nanocrystals embedded in an amorphous matrix. FIG. 5B shows (Co_{0.35}Fe_{0.65})_{73.5}Si_{15.5}Nb₃B₇Cu₁ nanoparticles with a particles size of about 10 nm. FIGS. 5C, and 5D are HRTEM images of FINEMT-type Fe_{73.5}Si_{15.5}Nb₃B₇Cu₁ alloy powders prepared by HPGA. FIG. 5C shows a-Fe nanocrystals embedded in an amorphous matrix and FIG. 5D shows Fe_{73.5}Si_{15.5}Nb₃B₇Cu₁ nanoparticles with a particle size of about 5-10 nm.

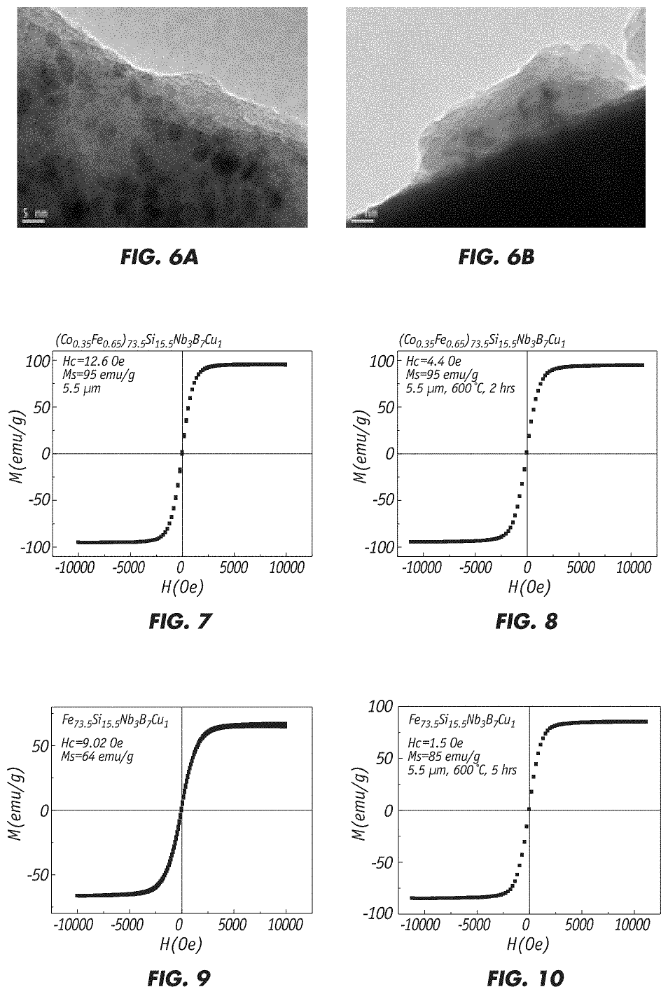

FIGS. 6A and 6B are HRTEM images of (Co_{0.35}Fe_{0.65})_{73.5}Zr₇B₄Cu₁ alloy powders made by HPGA. The microstructural features are similar to as ones for (Co_{0.35}Fe_{0.65})_{73.5}Si_{15.5}Nb₃B₇Cu₁ alloy powders prepared by the identical HPGA process as shown in FIGS. 5A and 5B.

FIG. 7 is a hysteresis loop of about 5.5 μm (Co_{0.35}Fe_{0.65})_{73.5}Si_{15.5}Nb₃B₇Cu₁ prepared by HPGA process. In this diagram, H is the applied magnetic field in Oersteds and M is the magnetization. Hc, which is the coercive force, is about 12 Oe.

FIG. 8 is a hysteresis loop of (Co_{0.35}Fe_{0.65})_{73.5}Si_{15.5}Nb₃B₇Cu₁ powder made by HPGA and annealed a temperature of 600° C. for 2 hrs under Ar/H₂ atmosphere. Hc is about 4.4 Oe, which is comparable to similar alloys prepared by melt-spun.

FIG. 9 is a hysteresis loop of 5.5 μm Fe_{73.5}Si_{15.5}Nb₃B₇Cu₁ powder made by HPGA. The Mₛ is 64 emu/g and the Hₑ is 9.02 Oe,

FIG. 10 is a hysteresis loop for Fe_{73.5}Si_{15.5}Nb₃B₇Cu₁ powder prepared by HPGA and annealed at a temperature of 600° C. for 2 hrs under Ar/H₂ atmosphere. The Hc is about 1.5 Oe, which is comparable to similar alloys prepared by melt-spun process.

Powdered alloys produced by HPGA can also be milled before undergoing annealing. For example, high-energy mechanical ball milling under liquid nitrogen (cryomilling) can be employed to break-down the HPGA-prepared microscale materials into nano-sized powder. High-energy ball milling, which has a much higher ratio of milling balls/powders, as compared to a conventional ball milling process, is an efficient means to generate a variety of nanostructured powder materials with several advantages as applicability to essentially all classes of materials and may be used for easy scaling from small to large quantities of materials. With milling, heavy cyclic deformation is induced in powders, which promotes (1) the formation of nanostructures by the structural decomposition of coarser-grained structures as a result of severe plastic deformation, and (2) penetration of nano-size particulates (nanoparticles) into the powders of other constituents. This then forms a nanocomposite at the single particle level. The introduction of liquid nitrogen into high-energy ball milling, in the “cryomilling” process, represents a new development for the cost-effective synthesis of nanostructured powders. Cryomilling can further increase the synthesis efficiency and simultaneously minimize the oxidation/contamination of the milled materials.

To avoid possible impurity-contamination in this milling approach, ceramic balls may be used instead of stainless-steel ones to minimize any Fe contamination. In addition, milling under an Ar atmosphere may be used to avoid possible oxidation. Before consolidation, the cryomilled powders or powder mixtures are degassed in vacuum (10⁻⁶ torr) to evacuate the potential trapped gas during the cryomilling process. The pressing of samples is carried out under processing conditions of 200 MPa, 340-500° C. and sintering times ranging from 30-60 minutes in an Argon atmosphere. The resultant powders are then sintered into a bulk sample with nearly theoretical density, by controlling the sintering atmosphere, sintering temperature and sintering time.

Microscale HITPERM-type (Co_{0.35}Fe_{0.65})₈₈Zr₇B₄Cu₁ powders with sizes around 16 μm were produced by HPGA and the sphere-shaped particles underwent high-energy mechanical ball milling into nanoscale powders in a protective atmosphere such as stearic acid in order to avoid oxidation. The nanopowders were annealed at a low temperature of 600° C., so that α-CoFe, which contributes a large magnetic moment to the soft magnetic (Co_{0.35}Fe_{0.65})₈₈Zr₇B₄Cu₁ powders, forms in the crystallization process in the amorphous and partially crystallized matrix. Hc of the (Co_{0.35}Fe_{0.65})₈₈Zr₇B₄Cu₁ powders prepared by HPGA was a little high than that of (Co_{0.35}Fe_{0.65})_{73.5}Si_{15.5}Nb₃B₇Cu₁.

The soft magnetic materials produced by HPGA can be consolidated into various lightweight bulk magnets that can be employed, for example, in small lightweight converters and inverters. For example, the final magnet of the bulk nanocomposites with optimized magnetic properties and targeted shape and size can be made with Rapid Hot Pressing (RHP) and Hot Isostatic Pressing (HIP). RHP is particularly suited for consolidating nanostructured powders into near-net shape samples with dense microstructures. Compared to conventional hot pressing, RHP equipped with rapid induction heating is better in retaining fine-grain microstructure. Because of significantly reduced sintering temperature and time, grain growth is significantly suppressed and the final products with fine grain size and high density can be achieved.

The foregoing has described the principles, preferred embodiment and modes of operation of the present invention. However, the invention should not be construed as limited to the particular embodiments discussed. Instead, the above-described embodiments should be regarded as illustrative rather than restrictive, and it should be appreciated that variations may be made in those embodiments by workers skilled in the art without departing from the scope of present invention as defined by the following claims.

What is claimed is:

1. A method of producing soft magnetic materials comprising:
(a) melting a metal to form a liquid metal;
(b) forming a continuous stream of the metal liquid; and
(c) directing high pressure inert gas into the continuous stream of liquid metal to generate droplets of the liquid metal, whereby the droplets solidify to form particles that exhibit soft magnetic properties.

2. The method of claim 1 further comprising (d) annealing the particles at a low annealing temperature.

3. The method of claim 3 wherein step (d) causes crystallization within the particles to form nanocrystal phases of α-CoFe or α-Fe.

4. The method of claim 3 wherein the nanocrystal phases have diameters that ranges from 5 to 10 nm.

5. The method of claim 3 wherein the annealing temperature ranges from 500 to 600° C.

6. The method of claim 1 wherein in step (b) the liquid metal passes through an elongated channel and exits through an aperture as a melt stream and step (c) comprises impinging inert gas into the melt stream.

7. The method of claim 5 wherein in step (b) the aperture is positioned within a spray chamber and in step (c) the impinging inert gas has a pressure of 800-1000 psi.

8. The method of claim 1 wherein step (c) comprises directing high pressure inert gas from a plurality of directions into the melt stream.

9. The method of claim 1 wherein step (a) comprises melting an alloy.

10. The method of claim 9 wherein the alloy is FeSiNbCuB, FeZrNbCu, CoFeZrCuB, or CoFeSiNbCuB.

11. The method of claim 1 wherein step (a) comprises melting the metal in a vacuum chamber or in an inert environment.

12. The method of claim 1 wherein the droplets solidify into particles at a cooling rate of 1×10⁵ to 5×10⁵ degrees C./s.

13. The method of claim 1 wherein the particles comprise nanocomposites.

14. The method of claim 13 wherein the nanocomposites have diameters in the range of 5 to 10 nm.

15. A method of fabricating soft nanocomposite magnetic materials comprising:
(a) melting a metal to form a liquid metal;
(b) forming a continuous stream of the metal liquid;
(c) directing high pressure inert gas into the continuous stream of liquid metal to generate droplets of the liquid metal, whereby the droplets solidify to form particles that exhibit soft magnetic properties; and
(d) annealing the microscale particles at a low annealing temperature to yield soft nanocomposite magnetic materials.

16. The method of claim 15 wherein step (d) causes crystallization within the particles to form nanocrystal phases of α-CoFe or α-Fe.

17. The method of claim 15 further comprising (e) consolidating the soft nanocomposite magnetic materials.

18. The method of claim 17 wherein step (e) forms magnets.

19. The method of claim 18 wherein the magnets comprises an alloy that is FeSiNbCuB, FeZrNbCu, CoFeZrCuB, or CoFeSiNbCuB.

20. The method of claim 18 wherein the magnets are incorporated in an inverter or converter.
